(19) United States
(12) Patent Application Publication
(10) Pub. No.: US 2004/0204170 A1
(43) Pub. Date: Oct. 14, 2004

(54) Mobile phone battery pack and battery cover with earphone-microphone earpiece jack

(76) Inventor: Harry A. Mkhitarian, Pasadena, CA (US)

Correspondence Address: CHRISTIE, PARKER & HALE, LLP, PO BOX 7068, PASADENA, CA, 91109-7068, US

(21) Appl. No.: 10/136,590

(22) Filed: May 1, 2002

(51) Int. Cl. H04M 1/00

(52) U.S. Cl. 455/572

(57) ABSTRACT

A battery pack and battery cover for use with a mobile communication device such as a mobile phone having battery contactors and speaker and microphone signal leads but without an earphone-microphone plug. The battery pack and battery cover permit a user to use an existing mobile phone and the like without a plug for a earphone and microphone headset to be used with an external earphone and microphone. The battery pack include a casing, a battery contained in the case, battery contacts accessible from the case, an earphone-microphone interface, and speaker and microphone signal lead contactors connected to the earphone-microphone interface. The battery cover includes a cover portion adapted to fit over a battery on a mobile communication device, an earphone-microphone port provided in the cover portion, and speaker and microphone signal lead contactors connected to the earphone-microphone interface. The earphone-microphone interface can be an earphone-microphone plug or a wireless transceiver adapted for communication with an earphone-microphone headset.

### FIELD OF THE INVENTION

The present invention is directed to detachable battery packs and battery covers for communication devices, and more particularly to a detachable battery pack or battery cover with a self-contained earphone-microphone earpiece jack for mobile phones.

### BACKGROUND OF THE INVENTION

The typical mobile or cellular phone has a main unit and a power supply. The main unit has a keypad, a display, and main communication electronics, all contained in a case. Battery contact leads are provided on a back of the main unit. An electrical-communication port for recharging the battery and for connecting the mobile phone to hands-free adapters for use in automobiles is nearly always provided on a side of exterior surface of the case of the main unit, e.g. on a bottom edge of the phone. Often, electrical contacts for the speaker and microphone are also provided on the back of the main unit. However, while some mobile phones have a jack for a headset earphone-microphone, many do not. The power supply, e.g., a battery, can be sealed in a self-contained battery pack which snaps or slides onto a back of the main unit, or can be just be a battery, which is placed in electrical contact with the battery contract leads on the main unit and held in place on the main unit with a battery cover.

It is often desirable to have a hands-free option on a communication device such as a mobile phone to allow a user to walk freely without holding the mobile handset to his face. Hands-free options often include a hands-free headset with at least one earphone speaker adapted to fit into or around a user's ear and a microphone receiver that is able to pick up a user's voice. The headset has a cord that with a terminating plug which can be plugged into a jack on the main body of the mobile phone. Again, while some mobile phones have a plug for an earphone-microphone jack, many phones do not. In these cases, a user wishing to use a earphone-microphone is relegated to purchase a new mobile phone model. This can be a costly option, particularly if the user has invested in mobile phone accessories (e.g. data cards, leather cases, face plates, chargers, belt clips, etc.) that are adapted only for use the mobile phone considered being replaced.

There accordingly remains a need for an adapter that permits mobile phones without a earphone-microphone jack to be converted for use with existing earphone-microphone headsets.

### SUMMARY OF THE INVENTION

According to one aspect of the present invention, a mobile phone battery pack with a speaker-microphone jack is provided. The battery pack is adapted to engage with a main unit of the mobile phone, and make electrical contact with earphone and microphone leads on the back of the main unit so as to deliver signals to the earphone and microphone jack.

In another aspect of the present invention, a mobile phone battery pack with a speaker-microphone jack is provided. The battery pack is adapted to engage with a main unit of the mobile phone, and make electrical contact with the electrical-communication port of the main unit to delivery signals to the earphone and microphone jack.

According to a further aspect of the present invention, a mobile phone battery cover with a speaker-microphone jack is provided. The battery cover is adapted to engage with a main unit of the mobile phone, and make electrical contact with the speaker and microphone leads on the back of the main unit to delivery signals to the earphone and microphone jack.

In yet another aspect of the present invention, a mobile phone battery cover with a earphone-microphone jack is provided. The battery cover is adapted to engage with a main unit of the mobile phone, and make electrical contact with the electrical-communication port on the main unit to delivery signals to the earphone and microphone jack.

Standard earphone-microphone units with plugs sized to connect to the jack on the battery packs and battery covers can be used and removed when not needed.

In lieu of a jack and plug, wireless transceivers can be used to establish communication between the earphone-microphone headset and the battery pack and battery case and then the main unit.

In the aspects of the invention where the battery pack or battery cover make electrical contact with the electrical-communication port of the main unit, the battery pack or battery cover preferably can have a shape and contour and have a replicate electrical-communication port so that mobile phones equipped with the battery pack or battery cover of the invention can continue to be used with existing battery chargers and hands-free adapters for automobiles.

The earphone-microphone jack on the battery pack and battery cover may be located on any external surface thereof, but can preferably be located on a side of the battery pack and battery cover for easy access.

Many of the attendant features of this invention will be more readily appreciated as the same becomes better understood by reference to the following detailed description and considered in connection with the accompanying drawings in which like reference symbols designate like parts throughout.

### BRIEF DESCRIPTION OF THE DRAWINGS

FIG. 1 illustrates a user operating a mobile phone with a earphone-microphone headpiece connected to a battery pack or battery cover with a earphone-microphone jack according to the present invention.

FIG. 2 is a top plan view of a flip style mobile phone with the flip cover closed and earphone and microphone fitted with a battery pack with a earphone-microphone jack of the invention.

FIG. 3 is a top plan view of the mobile phone of FIG. 2 with the flip cover shown in its open position.

FIG. 4 is a right side view of the mobile phone of FIG. 2.

FIG. 5 is a left side view of the mobile phone of FIG. 2.

FIG. 6 is a back view of the mobile phone of FIG. 2 with the battery pack attached.

FIG. 7 is a back view of the mobile phone of FIG. 2 with the battery pack removed to show the battery pack contactors and the earphone and microphone contacts.

FIG. 8 is a bottom view of the mobile phone of FIG. 7 without the battery pack attached and shows the electrical-communication port.

FIG. 9 is a back view of a battery pack for use with the phone of FIG. 7 showing the battery contacts and the earphone and microphone contacts and showing the contained battery and earphone-microphone jack in phantom.

FIG. 10 is a top plan view of flip style mobile phone fitted with a battery pack with an earphone and microphone jack of the invention, with the flip cover closed.

FIG. 11 is a left side view of the mobile phone with battery pack of FIG. 10.

FIG. 12 is a back view of the mobile phone of FIG. 10 with the battery pack of the invention attached.

FIG. 13 is a back view of battery pack for use with the phone of FIG. 10 showing the battery contacts, the contacts for the electrical-communication port and, in phantom, the contained battery and earphone-microphone jack.

FIG. 14 is a bottom view of the mobile phone with battery pack of FIG. 10 showing the replicate electrical-communication port on the base of the battery pack.

FIG. 15 is a back view of an embodiment of a mobile phone adapted for use with a battery cover (shown removed), showing a battery in place and the contacts for the earphone and microphone.

FIG. 16 is a back view of the battery cover for the mobile phone of FIG. 15, showing the earphone-microphone jack and contactors for the earphone and microphone.

FIG. 17 is a back view of an embodiment of a mobile phone adapted for use with a battery cover, showing a battery in place.

FIG. 18 is a back view of the battery cover for the mobile phone of FIG. 17, showing the earphone-microphone jack and contactors for the electrical-communication port on the base of the battery pack.

FIG. 19 is a bottom view of the mobile phone of FIG. 17 showing the replicate electrical-communication port on the base of the battery cover.

FIG. 20 is a back view of battery pack having a wireless earphone-microphone transmitter.

FIG. 21 is a back view of battery cover having a wireless earphone-microphone transmitter.

### DETAILED DESCRIPTION OF THE INVENTION

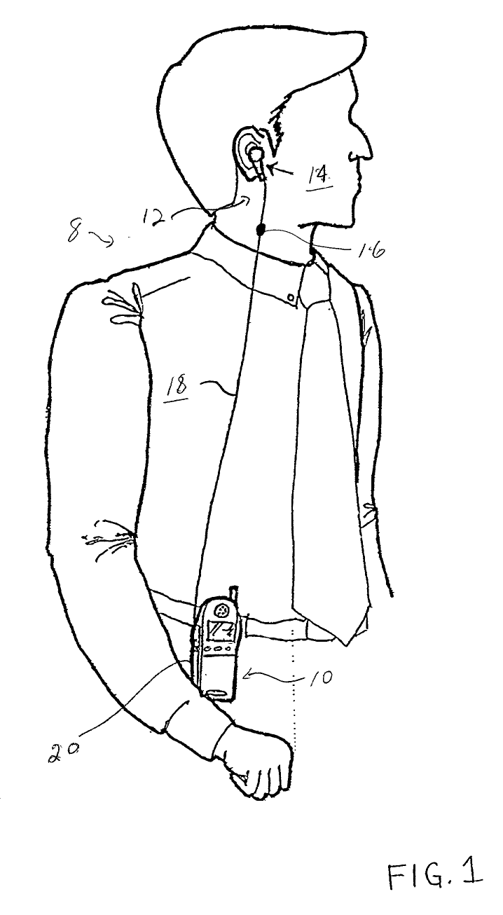

Referring to FIG. 1, there is shown a user 8 operating a mobile phone 10 with an earphone-microphone headset 12 having an earphone 14 and a microphone 16 connected with a lead wire 18 and connected to the battery pack or battery cover with an earphone-microphone jack 20 of the invention.

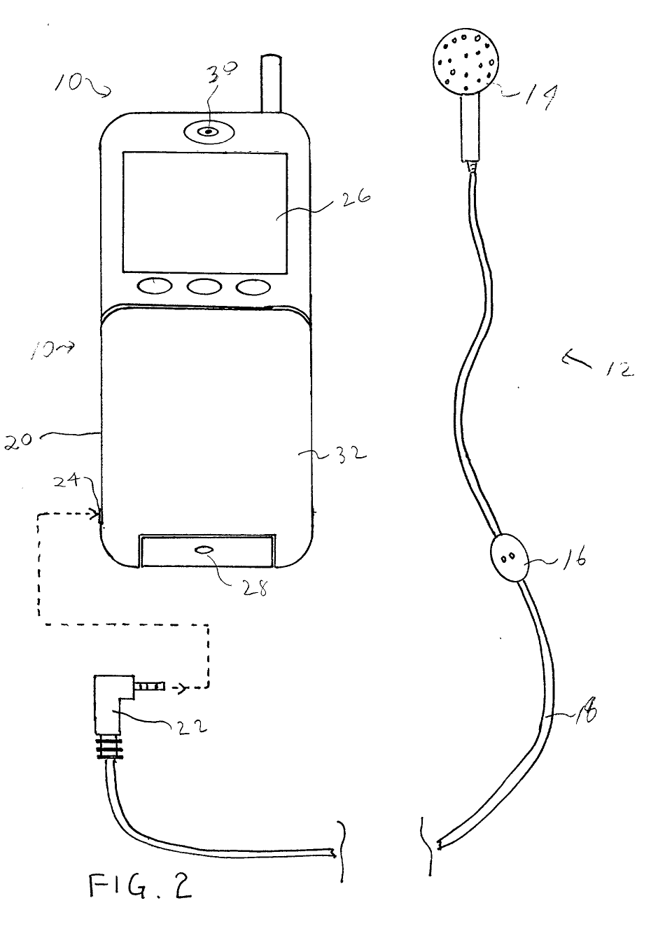

Turning to FIG. 2, there is shown a top plan view of a flip style mobile phone 10 and a standard earphone-microphone headset 12, the earphone-microphone headset having an earphone portion 14 and a microphone portion 16, shown as separate components. However, the earphone and microphone can be integrated into a single unit, if desired. Earphone 14 and microphone 16 are interconnected with a lead wire 18 which terminates in an earphone-microphone jack 22 which is adapted to engage with an earphone-microphone plug 24 integral with battery pack 20. Mobile phone 10 has a display 26, a microphone 28 and an earphone 30. Mobile phone 10 is shown with its flip cover 32 in a closed position.

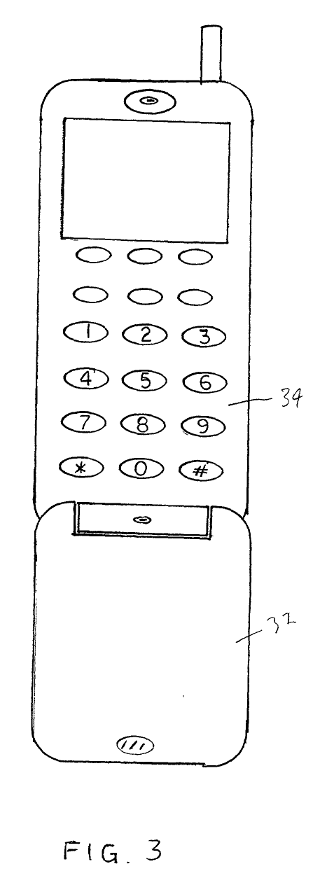

Turning next to FIG. 3, there is shown the mobile 10 with its flip cover 32 flipped open to expose keypad 34.

FIGS. 4 and 5 are respectively, a right side view and a left side view of the mobile phone of FIG. 2 equipped with the battery pack 20 with jack 24 of the invention. As can be seen, the mobile phone has a main body portion 36 which houses the electronics, the key pad, the display and has an antennae 38. Battery pack 20 attaches to a rear of mobile phone 10, earphone-microphone plug 24 can be seen in FIG. 5. While a side edge of battery pack 20 is ideal for earphone-microphone plug 24, earphone-microphone plug 24 can be placed at other portions of the battery pack.

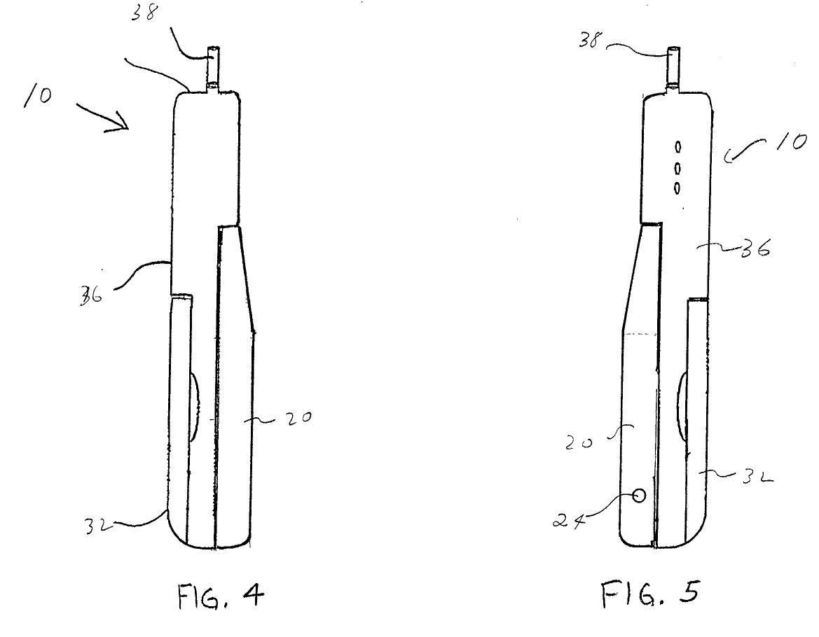

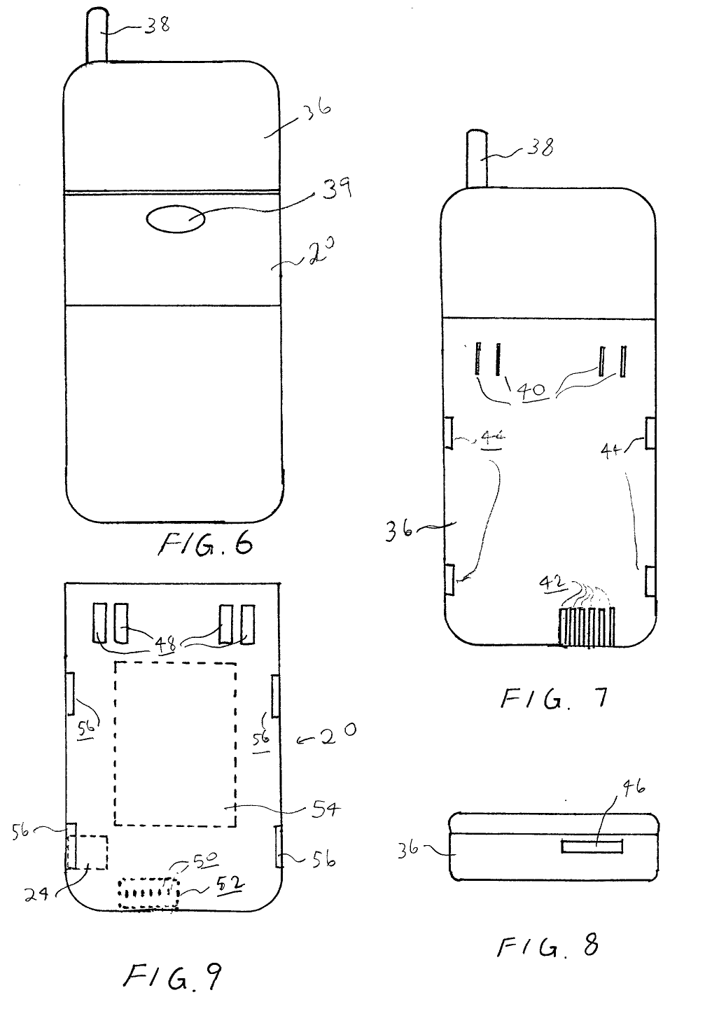

Turning to FIG. 6, there is shown a back plan view of mobile phone 10, showing main body portion 36 to which is attached battery portion 20. A release button 39 for battery pack can be provided on battery pack. FIG. 7 is a back view of the mobile phone of FIG. 2 with battery pack removed to show battery pack contactors 40 and earphone-microphone contacts 42. Slide engagement means 44 are provided on main body portion 36. Referring to FIG. 8, there is shown a bottom view of mobile phone 10 showing an electrical-communication port 46 located on the bottom of main body portion 36. Electrical-communication port can be used for recharging battery and/or connection to a automobile recharger/hands-free unit (not shown).

Referring to FIG. 9, there is shown a back view of battery pack 20 of battery pack, with battery contacts 48 as well as earphone and microphone contacts 50, which extends from an earphone/microphone contactors unit 52 (shown in phantom). The battery 54 is shown in phantom within battery pack 20. Sliders 56 are provided on back of battery pack for use in engaging with battery pack engagement means 44 on main body portion 36. Other known means to detachably attach a battery pack to a mobile phone can be used.

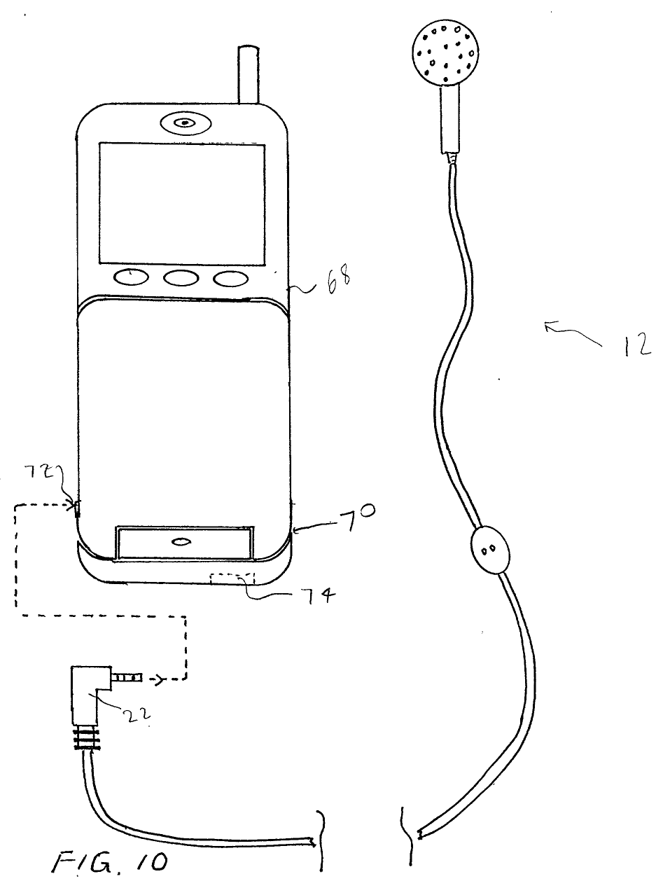

Referring to FIG. 10, there is shown a battery pack 70 with jack 72 and replicate port 74 adapted for use with mobile phones without earpiece and microphone contacts on a back face of a main body portion 36. Battery pack 70 can be utilized with the same type of earphone-microphone headset 12 as in the first embodiment of FIGS. 1-9. The earphone-microphone jack 22 is adapted to be electrically engaged with an earphone-microphone plug 72 of battery pack 70.

FIG. 11 is a left side of the mobile phone 68 fitted with battery pack 70 with jack 72 and replicate port 74.

FIG. 12 is a back view of mobile phone 68 with battery pack 70 attached thereto.

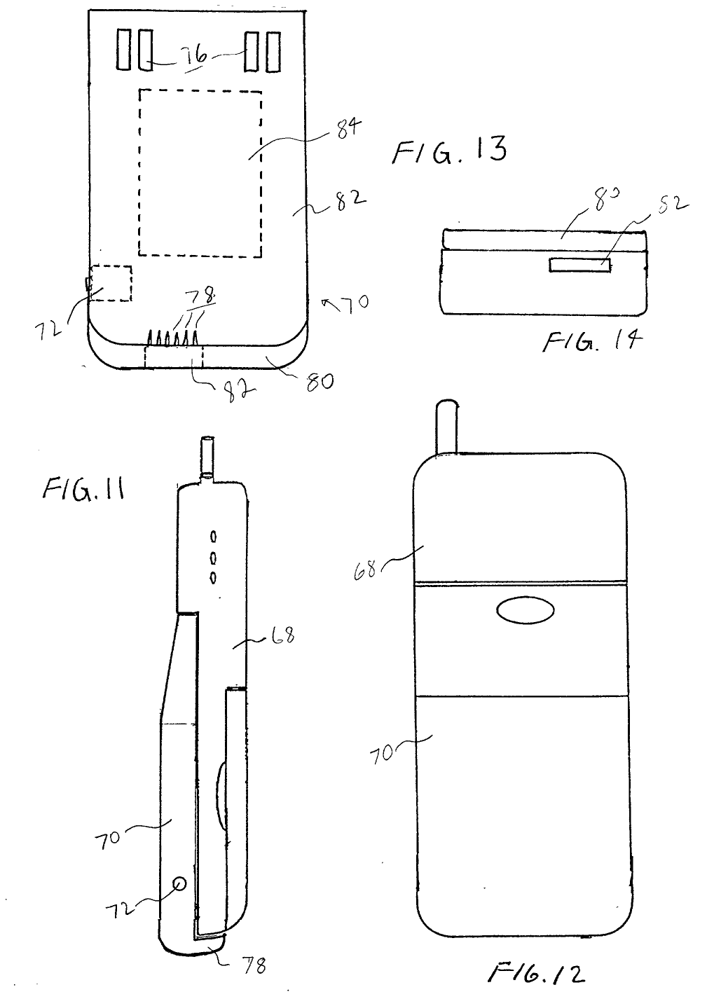

FIG. 13 is a back view of battery pack 70. As shown, battery pack contacts 76 are present and electrical-communication port contactors 78 extend from a battery pack exterior 80 which extends forwardly of a planar face 82, putting the electrical-communication port contactors 78 in alignment with a replicate electrical-communication port 82, as shown in FIG. 14. Referring back to FIG. 13, a battery 84 and earphone-microphone plug 72 are shown in phantom. Replicate electrical-communication port 82 sized and positioned such that the mobile phone equipped with the battery pack 70 can still be used with existing battery chargers and hands-free accessories for automobile use, will still fit within cradles for recharging, and the like.

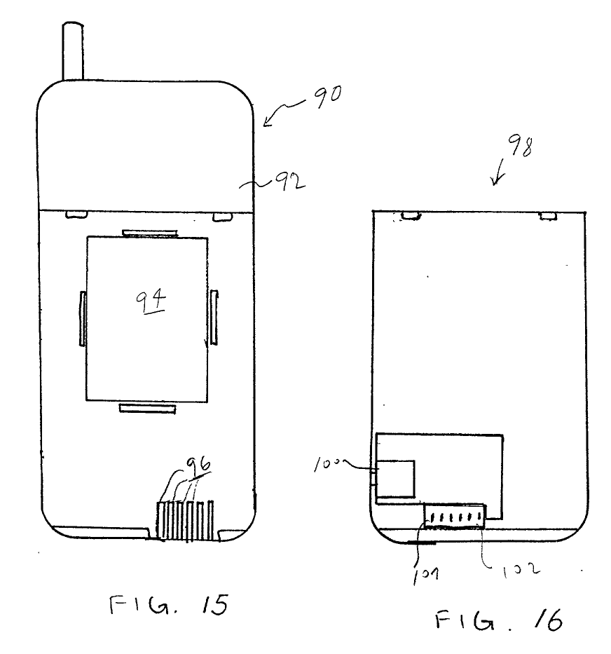

Turning now to FIG. 15, there is shown an embodiment of a mobile phone 90 having a main body portion 92 onto which a battery 94 is placed on a back thereof. Earphone and microphone contacts 96 are located on back of a main body portion.

Referring to FIG. 16, there is shown a back view of a battery cover 98 adapted to be engaged to cover battery 94 on main body portion 92. Battery cover 98 has an earphone-microphone jack 100 and an earphone and microphone contactor unit 102 located thereon, with contacts 104 of the contactor unit 102 aligned such that they make electrical contact with earphone and microphone contact 96 when battery cover 98 is engaged with main body portion 92.

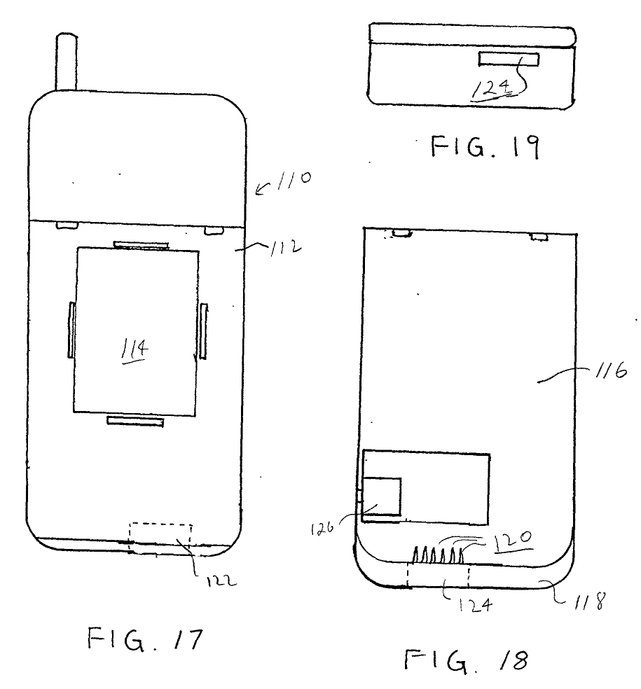

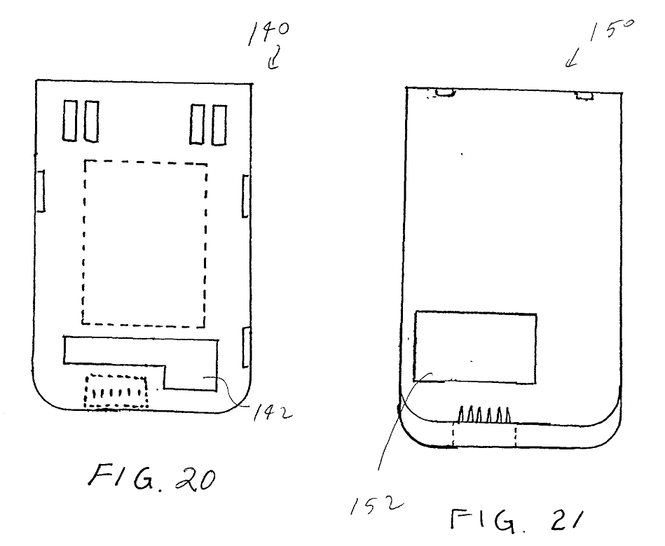

Turning to FIG. 17, there is shown an embodiment of a mobile phone 110 without earphone microphone contacts but with an electrical communication port 122 having a main body portion 112 onto which fits a battery 114 on a back portion thereof.

FIG. 18 is a back view of a battery cover 116 adapted to fit to the back of main body portion 112 and secure the battery therein. Battery cover 116 has a battery cover extension 118 which extends outwardly therefrom. Electrical-communication port contactors 120 extend from battery cover extension 118 and are sized and aligned such that they make electrical contact with electrical-communication port 122 on the bottom of the main body portion 112. Battery cover has a built-in earplug-microphone plug 126. When battery cover 116 is engaged with main body portion 112, electrical communication port connectors 120 will make electrical contact and engage with electrical-communication port 122 of the main body portion 112. Electrical contact with earplug-microphone plug 126 will thus be made, thereby allowing mobile phone 110 without any built-in earphone-microphone plug to nonetheless be used with accessory earphone and microphone or headsets. This feature permits a user to use the mobile phone in a hands-free arrangement by using conventionally available earphone and microphone headsets.

Referring to FIG. 20, there is shown a back view of a battery pack 140 having a wireless earphone microphone transceiver 142. In other respects, battery pack 140 is similar to a battery pack shown as described in FIG. 9. Turning to FIG. 21, there is shown a battery cover 150 with a wireless earphone-microphone transceiver 152, which is similar to the battery cover shown in FIG. 18 except that in lieu of having a plug, a transceiver 152 is provided. The wireless earphone-microphone transceivers can comprise a radio frequency device or any short range communication device.

Also, while the invention has been described primarily with reference to mobile phones, the battery pack/battery cover can be used for communication devices such as cordless phones for use in wired networks, and the like.

The drawings and the foregoing description are not intended to represent the only form of the invention in regard to the details of its construction and manner of operation. In fact, it will be evident to one skilled in the art that modifications and variations may be made without departing from the spirit and scope of the invention. Although specific terms have been employed, they are intended in a generic and descriptive sense only and not for the purpose of limitation.

What is claimed is:

1. A battery pack for use with mobile communication devices with battery contactors and speaker and microphone signal leads but without an earphone-microphone plug, the battery pack comprising:
a casing;
a battery contained in the casing;
battery contacts accessible from the casing;
an earphone-microphone interface provided in the casing; and
speaker and microphone signal lead contactors connected to the earphone-microphone interface.

2. The battery pack of claim 1, wherein the earphone-microphone interface is an earphone-microphone plug adapted for engagement with a jack of an earphone-microphone headset.

3. The battery pack of claim 1, wherein the earphone-microphone interface is a wireless earphone-microphone transceiver, adapted to communicate with a wireless earphone-microphone headset.

4. The battery pack of claim 1, wherein the mobile communication device is a mobile phone with the speaker and microphone signal leads located on a back side thereof, and wherein the battery contactors and the speaker and microphone signal lead contactors are adapted to make electrical contact with the battery contacts and the speaker and microphone signal leads, respectively, when the battery pack is engaged with the mobile phone.

5. The battery pack of claim 1, wherein the mobile communication device is a mobile phone with the speaker and microphone signal contacts provided in an electrical-communication port, and wherein the speaker and microphone signal lead contactors are adapted to make electrical contact with the speaker and microphone signal contacts in the electrical-communication port when the battery pack is engaged with the mobile phone.

6. The battery pack of claim 5, wherein a replicate electrical-communication port is provided on the casing of the battery pack.

7. The battery pack of claim 5, wherein a replicate electrical-communication port is provided on the casing of the battery pack and is aligned for engagement with the electrical-communication port of the mobile phone.

8. The battery pack of claim 1, wherein the communication device is a cordless phone adapted for wiring to a land line.

9. A battery cover for use with mobile communication devices with speaker and microphone signal leads but without an earphone-microphone plug, the battery cover comprising:
a cover portion adapted to fit over a battery on a mobile communication device;
an earphone-microphone interface provided in the cover portion; and
speaker and microphone signal lead contactors connected to the earphone-microphone port.

10. The battery cover of claim 9, wherein the earphone-microphone interface is an earphone-microphone plug adapted for engagement with a jack of an earphone-microphone headset.

11. The battery pack of claim 9, wherein the earphone-microphone interface is a wireless earphone-microphone transceiver, adapted to communicate with a wireless earphone-microphone headset.

12. The battery cover of claim 9, wherein the mobile communication device is a mobile phone with the speaker and microphone signal leads located on a back side thereof, and wherein the speaker and microphone signal lead contactors are adapted to make electrical contact with the speaker and microphone signal leads when the battery over is engaged with the mobile phone.

13. The battery cover of claim 9, wherein the mobile communication device is a mobile phone with the speaker and microphone signal contacts provided in an electrical-communication port, and wherein the speaker and microphone signal lead contactors are adapted to make electrical contact with the speaker and microphone signal contacts in the electrical-communication port when the battery cover is engaged with the mobile phone.

14. The battery cover of claim 13, wherein a replicate electrical-communication port is provided on the battery cover.

15. The battery cover of claim 13, wherein a replicate electrical-communication port is provided on the battery cover and is aligned with the electrical-communication port of the mobile phone.
